(19) United States
(12) Patent Application Publication
(10) Pub. No.: US 2025/0061244 A1
(43) Pub. Date: Feb. 20, 2025

(54) SIMULATION METHOD, PROGRAM, AND STORAGE MEDIUM

(71) Applicant: Kioxia Corporation, Tokyo (JP)

(72) Inventors: Weiting WANG, Kawasaki (JP); Kazuyuki HINO, Yokohama (JP)

(73) Assignee: Kioxia Corporation, Tokyo (JP)

(21) Appl. No.: 18/794,149

(22) Filed: Aug. 5, 2024

(30) Foreign Application Priority Data
Aug. 14, 2023 (JP) 2023-132054

(51) Int. Cl. G06F 30/17

(52) U.S. Cl. CPC G06F 30/17

(57) ABSTRACT

A simulation method includes correcting a layout of a stacked structure based on a shape of the stacked structure; calculating a first feature value of the corrected layout; and simulating a polishing process for the corrected layout based on the first feature value.

### CROSS-REFERENCE TO RELATED APPLICATION

This application is based upon and claims the benefit of priority from Japanese Patent Application No. 2023-132054, filed Aug. 14, 2023, the entire contents of which are incorporated herein by reference.

### FIELD

Embodiments described herein relate generally to a simulation method, a program, and a storage medium.

### BACKGROUND

A technique is known for simulating a manufacturing process of a semiconductor device. A layout of a pattern in the manufacturing process of the semiconductor device can be predicted by simulation processing. On the other hand, as the semiconductor device is highly integrated, a cost required for the simulation processing increases.

### DESCRIPTION OF THE DRAWINGS

FIG. 1 is a block diagram showing an example of a hardware configuration of a simulation device according to a first embodiment.

FIG. 2 is a block diagram showing an example of a functional configuration of the simulation device according to the first embodiment.

FIG. 3 is a diagram showing an example of a data structure of layout data stored in the simulation device according to the first embodiment.

FIG. 4 is a cross-sectional diagram taken along line IV-IV of FIG. 3 showing an example of a cross-sectional structure of a stacked structure corresponding to the layout data stored in the simulation device according to the first embodiment.

FIG. 5 is a diagram showing an example of a rule table stored in the simulation device according to the first embodiment.

FIG. 6 is a flowchart showing an example of simulation processing involving layout correction processing in the simulation device according to the first embodiment.

FIG. 7 is a cross-sectional diagram showing an example of simulation processing of a film forming process in the simulation device according to the first embodiment.

FIG. 8 is a cross-sectional diagram showing an example of the layout correction processing in the simulation device according to the first embodiment.

FIG. 9 is a cross-sectional diagram showing an example of simulation processing of a polishing process in the simulation device according to the first embodiment.

FIG. 10 is a set of cross-sectional diagrams showing an example of a cross-sectional structure of a stacked structure that is a target of simulation processing of a polishing process in a simulation device according to a second embodiment.

FIG. 11 is a diagram showing an example of a rule table stored in the simulation device according to the second embodiment.

FIG. 12 is a flowchart showing an example of simulation processing involving layout correction processing in the simulation device according to the second embodiment.

FIG. 13 is a set of cross-sectional diagrams showing a first example of first layout correction processing and polishing process simulation processing in the simulation device according to the second embodiment.

FIG. 14 is a set of cross-sectional diagrams showing a first example of second layout correction processing and polishing process simulation processing in the simulation device according to the second embodiment.

FIG. 15 is a set of cross-sectional diagrams showing a first example of third layout correction processing and polishing process simulation processing in the simulation device according to the second embodiment.

FIG. 16 is a set of cross-sectional diagrams showing a second example of the first layout correction processing and polishing process simulation processing in the simulation device according to the second embodiment.

FIG. 17 is a set of cross-sectional diagrams showing a second example of the second layout correction processing and polishing process simulation processing in the simulation device according to the second embodiment.

FIG. 18 is a set of cross-sectional diagrams showing a second example of the third layout correction processing and polishing process simulation processing in the simulation device according to the second embodiment.

### DETAILED DESCRIPTION

Embodiments provide a simulation method, a program, and a storage medium in which an accuracy is improved while an increase in cost is reduced.

In general, according to one embodiment, a simulation method includes correcting a layout of a stacked structure based on a shape of the stacked structure; calculating a first feature value of the corrected layout; and simulating a polishing process for the corrected layout based on the first feature value.

Hereinafter, embodiments will be described with reference to drawings. In the following description, elements having the same function and configuration are designated by a common reference numeral.

### 1. FIRST EMBODIMENT

### 1.1 Configuration of Simulation Device

### 1.1.1 Hardware Configuration

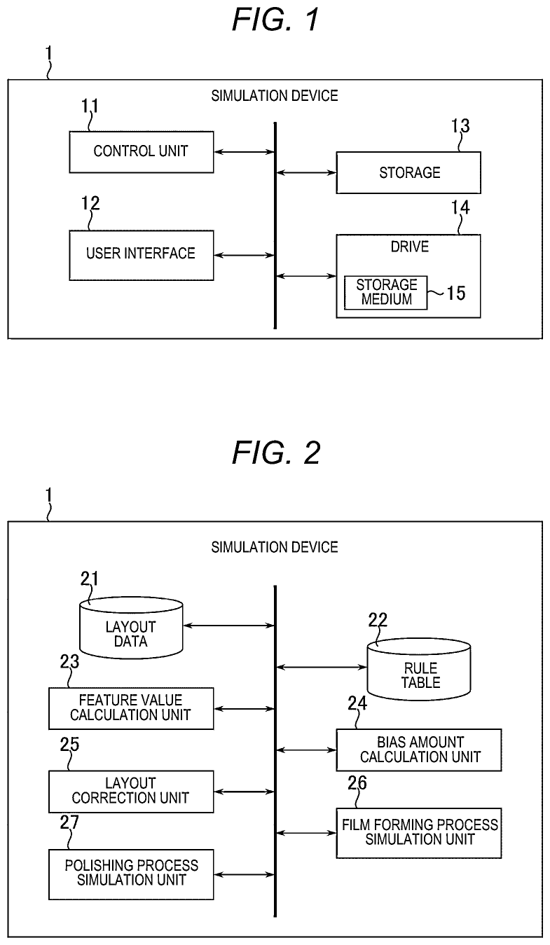

FIG. 1 is a block diagram showing an example of a hardware configuration of a simulation device according to a first embodiment. As shown in FIG. 1, a simulation device 1 includes a control unit 11, a user interface 12, a storage 13, a drive 14, and a storage medium 15.

The simulation device 1 is an information processing device configured to execute simulation processing for predicting a three-dimensional shape of a stacked structure in a manufacturing process of a semiconductor device. The manufacturing process simulated by the simulation device includes, for example, a film forming process and a polishing process. The film forming process includes, for example, a film forming process by any film forming method such as chemical vapor deposition (CVD), atomic layer deposition (ALD), and sputtering. The polishing process includes, for example, chemical mechanical polishing (CMP). The simulation device 1 is configured to correct layout data of a pattern obtained by simulation processing of the film forming process. The simulation device 1 is configured to execute simulation processing of the polishing process based on the layout data after the correction.

The control unit 11 is a circuit that performs overall control of each element of the simulation device 1. The control unit 11 includes a central processing unit (CPU), a random access memory (RAM), a read only memory (ROM), and the like. The ROM of the control unit 11 stores a program and the like used in various processing in the simulation device 1. The CPU of the control unit 11 controls the entire simulation device 1 in accordance with the program stored in the ROM of the control unit 11. The RAM of the control unit 11 is used as a work area of the CPU of the control unit 11.

The user interface 12 is an interface that governs communication between a user and the control unit 11. The user interface 12 includes an input device and an output device. The input device includes, for example, a touch panel, an operation button, and the like. The output device includes, for example, a liquid crystal display (LCD) or an electroluminescence (EL) display. The user interface 12 converts an input from the user into an electrical signal and then transmits the electrical signal to the control unit 11. The user interface 12 outputs an execution result of various processing based on the input from the user, to the user.

The storage 13 includes, for example, a hard disk drive (HDD) or a solid state drive (SSD). The storage 13 stores data used in the various processing in the simulation device 1.

The drive 14 is a device for reading software stored in the storage medium 15. The drive 14 includes, for example, a compact disk (CD) drive, a digital versatile disk (DVD) drive, and the like.

The storage medium 15 is a medium that stores the software by means of electrical, magnetic, optical, mechanical, or chemical action. The storage medium 15 may store a program for executing the various processing in the simulation device 1.

### 1.1.2 Functional Configuration

FIG. 2 is a block diagram showing an example of a functional configuration of the simulation device according to the first embodiment.

As shown in FIG. 2, the CPU of the control unit 11 loads the program stored in the ROM of the control unit 11 or in the storage medium 15 to the RAM of the control unit 11. The CPU of the control unit 11 interprets and executes the program loaded in the RAM of the control unit 11. As a result, the simulation device 1 functions as a computer including a feature value calculation unit 23, a bias amount calculation unit 24, a layout correction unit 25, a film forming process simulation unit 26, and a polishing process simulation unit 27. In addition, the simulation device 1 stores layout data 21 and a rule table 22.

The layout data 21 is data indicating a two-dimensional layout of the stacked structure in the manufacturing process of the semiconductor device, which is a target of the simulation processing.

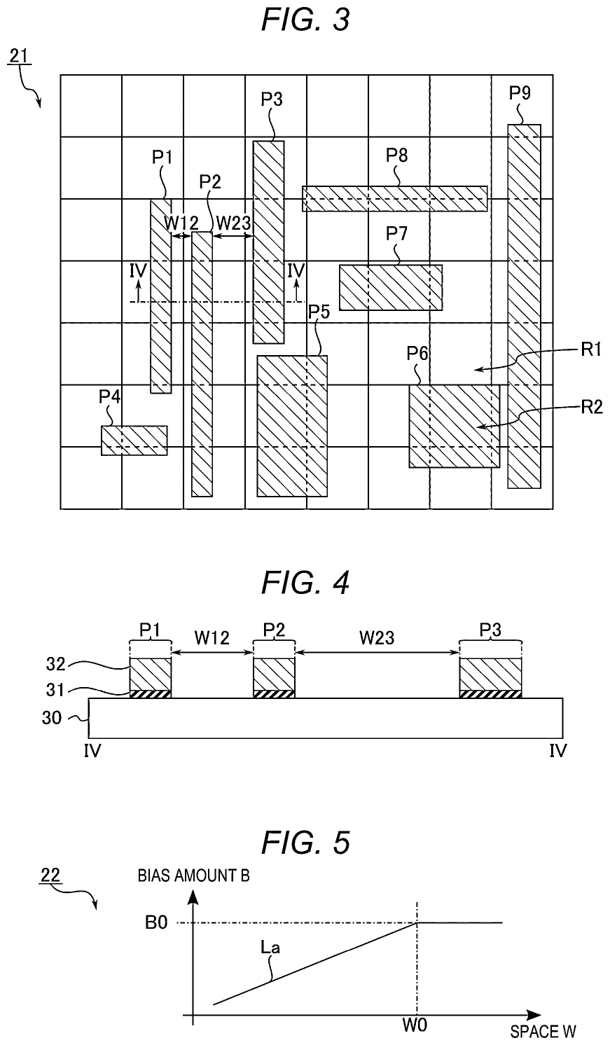

FIG. 3 is a diagram showing an example of a data structure of layout data stored in the simulation device according to the first embodiment. FIG. 4 is a cross-sectional diagram taken along line IV-IV of FIG. 3 showing an example of a cross-sectional structure of a stacked structure corresponding to the layout data stored in the simulation device according to the first embodiment. As shown in FIGS. 3 and 4, the layout data 21 is data corresponding to a two-dimensional distribution of a pattern P formed on a substrate 30 under manufacturing of the semiconductor device.

The examples in FIGS. 3 and 4 show when nine rectangular patterns P1 to P9 are distributed on the substrate 30. Each of the patterns P1 to P9 is, for example, a transistor under manufacturing. More specifically, each of the patterns P1 to P9 has a stacked structure of an insulator film 31 and a conductor film 3 formed on the substrate 30. Each of the patterns P1 to P9 is not limited to a transistor and may have any stacked structure. In this situation, the stacked structure forming each of the patterns P1 to P9 may be a plurality of films having different film types (for example, materials). The patterns P1 and P2 are provided parallel to each other with a space W12 interposed therebetween. The patterns P2 and P3 are provided parallel to each other with a space W23 interposed therebetween.

The pattern P in the layout data 21 is managed, for example, for each of a plurality of sub-regions R dividing a region on the substrate 30 in a matrix shape. Specifically, the pattern P1 distributed over four sub-regions R is managed for each of the four sub-regions R.

The feature value calculation unit 23 is a functional block that calculates a feature value related to the pattern P in the layout data 21 for each sub-region R. The feature value is a parameter applied to the simulation processing of the film forming process and the simulation processing of the polishing process. The feature value includes, for example, an area ratio, a width, and a perimeter length of the pattern P in the sub-region R.

The area ratio is a ratio of an area of the pattern P to an area of the sub-region R. Specifically, for example, a pattern is not formed in the sub-region R1. Therefore, the area ratio in the sub-region R1 is 0%. A part of the pattern P6 is formed in a sub-region R2 over an entire region. Therefore, the area ratio in the sub-region R2 is 100%.

The width is a length of a minor axis of the pattern P in the sub-region R. The perimeter length is a length of an outer periphery of the pattern P in the sub-region R. Specifically, for example, both the width and the perimeter length of the sub-region R1 are 0. Each of a width and a perimeter length of the sub-region R2 is a length of a side of the sub-region R2 and a length of an outer periphery of the sub-region R2.

The feature value of the layout data 21 as described above is updated in accordance with the execution of the simulation processing of the film forming process and the simulation processing of the polishing process.

The bias amount calculation unit 24 is a functional block that calculates a bias amount B. The bias amount B is a parameter applied to layout correction processing. The layout correction processing is processing of correcting the layout data 21 applied to the simulation processing of the polishing process, before the execution of the simulation processing of the polishing process. The bias amount calculation unit 24 calculates the bias amount B for each set of two patterns P adjacent to each other based on the rule table 22.

FIG. 5 is a diagram showing an example of a data structure of a rule table stored in the simulation device according to the first embodiment.

As shown in FIG. 5, the rule table 22 is data that defines a relationship between a space W, which is between the two adjacent patterns P, and the bias amount B. In the example of FIG. 5, the relationship between the space W and the bias amount B is represented by a line La. According to the line La, when the space W is less than a value W0, the bias amount B linearly increases with an increase in the space W. Further, when the space W is equal to or more than the value W0, the bias amount B is substantially constant at a value B0. The rule table 22 shown in FIG. 5 is an example, and the relationship between the space W and the bias amount B may be defined by a line having any shape regardless of the line La.

The layout correction unit 25 is a functional block that executes the layout correction processing based on the bias amount B to correct the layout data 21. Specifically, the layout correction unit 25 increases a width of each of the two patterns P such that the space W between the two adjacent patterns P is narrowed in accordance with the corresponding bias amount B.

The film forming process simulation unit 26 is a functional block that executes the simulation processing of the film forming process. The simulation processing of the film forming process executed by the film forming process simulation unit 26 is simple simulation processing. Therefore, a shape of the pattern P is substantially maintained before and after the simulation processing of the film forming process executed by the film forming process simulation unit 26.

The polishing process simulation unit 27 is a functional block that executes the simulation processing of the polishing process. The simulation processing of the polishing process executed by the polishing process simulation unit 27 is simple simulation processing. Therefore, the shape of the pattern P is substantially maintained before and after the simulation processing of the polishing process executed by the polishing process simulation unit 27.

### 1.2 Simulation Processing Involving Layout Correction Processing

Simulation processing involving layout correction processing in the simulation device according to the first embodiment will be described.

### 1.2.1 Flowchart

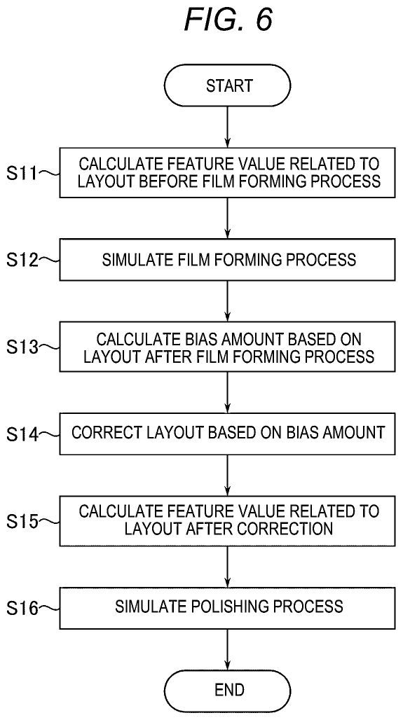

FIG. 6 is a flowchart showing an example of the simulation processing involving the layout correction processing in the simulation device according to the first embodiment. In the manufacturing process of the semiconductor device, FIG. 6 shows a series of processing, when a shape of the stacked structure is simulated when the film forming process and the polishing process are executed in this order.

When an instruction to start the simulation processing of the film forming process is received from the user (start), the feature value calculation unit 23 calculates the feature value related to the layout data 21 before the film forming process (S11). Specifically, the feature value calculation unit 23 calculates a parameter including the area ratio, the width, and the perimeter length related to the pattern P in the layout data 21 for each sub-region R.

The film forming process simulation unit 26 executes the simulation processing of the film forming process based on the feature value calculated in the processing of S11 (S12). As a result, the new pattern P is formed by film-forming a new film on the pattern P in the layout data 21. After the processing of S12, the layout data 21 is updated in accordance with the pattern P after the film forming.

The bias amount calculation unit 24 calculates the bias amount B based on the layout data 21 updated in the processing of S12 with reference to the rule table 22 (S13). Specifically, the bias amount calculation unit 24 calculates the bias amount B based on the space W between adjacent patterns P.

The layout correction unit 25 corrects the layout data 21 based on the bias amount B calculated in the processing of S13 (S14). Specifically, the layout correction unit 25 widens the width of each of the two patterns P such that the space W between the two adjacent patterns P is narrowed in accordance with the bias amount B.

The feature value calculation unit 23 calculates the feature value related to the corrected layout data 21 by the processing of S14 (S15).

The polishing process simulation unit 27 executes the simulation processing of the polishing process based on the feature value calculated in the processing of S15 (S16). As a result, the simulation processing of the polishing process is executed, which is based on the pattern P in consideration of the bias amount B. After the processing of S16, the layout data 21 is updated in accordance with the pattern P after the polishing.

When the processing in S16 is ended, simulation processing involving the layout correction processing is ended (end).

### 1.2.2 Specific Example

Next, a specific example of the simulation processing involving the layout correction processing in the simulation device according to the first embodiment will be described.

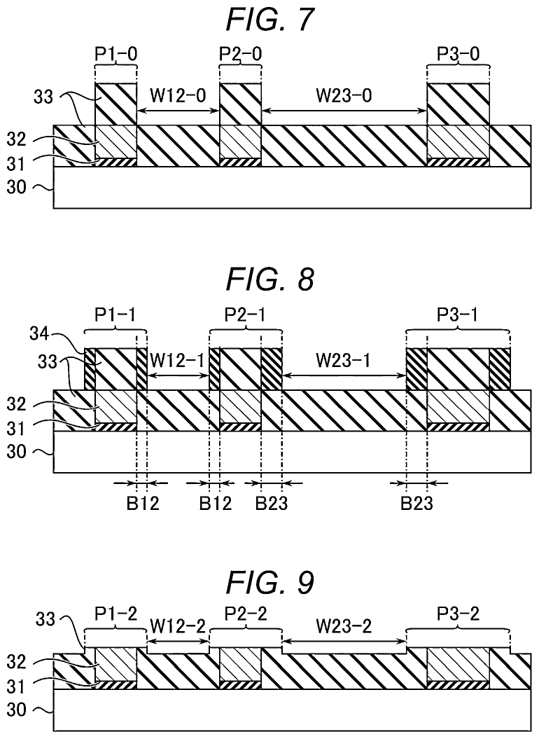

FIG. 7 is a cross-sectional diagram showing an example of simulation processing of a film forming process in the simulation device according to the first embodiment. FIG. 8 is a cross-sectional diagram showing an example of the layout correction processing in the simulation device according to the first embodiment. FIG. 9 is a cross-sectional diagram showing an example of simulation processing of a polishing process in the simulation device according to the first embodiment. Each of the cross-sectional diagrams shown in FIGS. 7, 8, and 9 corresponds to the cross-sectional diagram of the stacked structure after the processing of S12, the processing of S14, and the processing of S16 when the processing shown in FIG. 6 is executed with respect to the cross-sectional diagram shown in FIG. 4.

First, the simulation processing of the film forming process will be described.

As shown in FIG. 7, an insulator film 33 is provided over an entire surface by the simulation processing of the film forming process. The insulator film 33 forms patterns P1-0, P2-0, and P3-0.

As described above, the shape of the pattern P is substantially maintained before and after the simulation processing of the film forming process. Therefore, a width of the insulator film 33 forming the pattern P1-0 is substantially equal to a width of the conductor film 32 below the insulator film 33 forming the pattern P1-0. A width of the insulator film 33 forming the pattern P2-0 is substantially equal to a width of the conductor film 32 below the insulator film 33 forming the pattern P2-0. A width of the insulator film 33 forming the pattern P3-0 is substantially equal to a width of the conductor film 32 below the insulator film 33 forming the pattern P3-0. A space W12-0 between the pattern P1-0 and the pattern P2-0 is substantially equal to the space W12 between the pattern P1 and the pattern P2. A space W23-0 between the pattern P2-0 and the pattern P3-0 is substantially equal to the space W23 between the pattern P2 and the pattern P3.

Next, the layout correction processing will be described.

The bias amount calculation unit 24 calculates a bias amount B12 based on the space W12-0. The bias amount calculation unit 24 calculates a bias amount B23 based on the space W23-0.

As shown in FIG. 8, the layout correction unit 25 widens a width of the pattern P1-0 and a width of the pattern P2-0 such that the space W12-0 is narrowed in accordance with the bias amount B12. Specifically, the layout correction unit 25 adds a virtual insulator film 34 having a width of the bias amount B12 to a side wall of the insulator film 33 corresponding to the pattern P1-0 on a side of the pattern P2-0, and adds the virtual insulator film 34 having the width of the bias amount B12 to a side wall of the insulator film 33 corresponding to the pattern P2-0 on a side of the pattern P1-0. In addition, the layout correction unit 25 widens the width of the pattern P2-0 and a width of the pattern P3-0 such that the space W23-0 is narrowed in accordance with the bias amount B23. Specifically, the layout correction unit 25 adds the virtual insulator film 34 having a width of the bias amount B23 to a side wall of the insulator film 33 corresponding to the pattern P2-0 on a side of the pattern P3-0, and adds the virtual insulator film 34 having the width of the bias amount B23 to the side wall of the insulator film 33 corresponding to the pattern P3-0 on the side of the pattern P2-0. The insulator film 34 is, for example, an insulator having the same characteristics as that of the insulator film 33.

As a result, each of the patterns P1-0, P2-0, and P3-0 is corrected to patterns P1-1, P2-1, and P3-1. Each of the space W12-0 and the space W23-0 is corrected to the space W12-1 and the space W23-1.

Next, the simulation processing of the polishing process will be described.

As shown in FIG. 9, the insulator film 33 and the insulator film 34 on an upper surface of the conductor film 32 are removed by the simulation processing of the polishing process. Accordingly, a region of which the insulator film 33 is provided on a side of the conductor film 32 and that is not protected by the insulator film 34 is also slightly removed. As a result, the conductor film 32 and the insulator film 33 form patterns P1-2, P2-2, and P3-2.

As described above, the shape of the pattern P is substantially maintained before and after the simulation processing of the polishing process. Therefore, widths of the conductor film 32 and the insulator film 33 forming the pattern P1-2 are substantially equal to widths of the conductor film 32 and the insulator film 34 forming the pattern P1-1. A width of the conductor film 32 and the insulator film 33 forming the pattern P2-2 is substantially equal to a width of the conductor film 32 and the insulator film 34 forming the pattern P2-1. A width of the conductor film 32 and the insulator film 33 forming the pattern P3-2 is substantially equal to a width of the conductor film 32 and the insulator film 34 forming the pattern P3-1. A space W12-2 between the pattern P1-2 and the pattern P2-2 is substantially equal to the space W12-1. A space W23-2 between the pattern P2-2 and the pattern P3-2 is substantially equal to the space W23-1.

### 1.3 Effects According to First Embodiment

According to the first embodiment, the bias amount calculation unit 24 calculates the bias amount B12 based on the space W12 between two patterns P1 and P2 adjacent to each other. The layout correction unit 25 widens the width of the pattern P2 toward a side of the pattern P1 and the width of the pattern Pl toward a side of the pattern P2 by the bias amount B12. That is, the layout correction unit 25 corrects the layout data 21 based on the space W12. The feature value calculation unit 23 calculates a feature value of the corrected layout data 21. The polishing process simulation unit 27 simulates a polishing process for the corrected layout data 21 based on the feature value. As a result, even after simulation processing of a simple film forming process in which widths of the patterns P1 and P2 are not likely to change before and after the simulation processing, effective widths of the patterns P1 and P2 can be reproduced.

In addition, the simulation processing of the film forming process and the polishing process is executed with respect to a large number of patterns P formed on a wafer. As a result, when a detailed model is used to execute the simulation processing of the film forming process and the polishing process, it is difficult to complete the processing within a realistic time. Therefore, the simulation processing of the simple film forming process and polishing process may be applied, in which the width of the pattern P is not likely to change before and after the simulation processing. In the simulation processing of the simple film forming process and polishing process, for example, the area ratio, the width, and the perimeter length of the pattern P are used as the feature value (parameter). In this situation, in the simulation processing of the polishing process, the area ratio of the pattern P formed in an actual film forming process may not be reproduced.

Meanwhile, a tendency of a level difference of a stacked structure after an actual polishing process may be strongly correlated with the area ratio of the pattern P formed in the actual film forming process. Therefore, when after the simulation processing of the simple film forming process, the simulation processing of the simple polishing process is executed as it is, there is a possibility that the tendency of the level difference of the stacked structure after the actual polishing process may not be simulated.

According to the first embodiment, the bias amount calculation unit 24 calculates the bias amount B corresponding to a change amount in the width of the pattern P before and after the actual film forming process, based on the shape (geometry) of the pattern P, particularly the space W between the two patterns P adjacent to each other. As a result, in the simulation processing of the polishing process, the area ratio of the pattern P formed in the actual film forming process can be reproduced. Therefore, an accuracy of a level difference shape after the polishing process can be improved while an increase in a simulation cost is reduced.

In addition, the bias amount calculation unit 24 calculates the bias amount B23 based on the space W23 between the pattern P3 adjacent to the pattern P2 on a side opposite to the pattern P1 and the pattern P2. The layout correction unit 25 widens the width of the pattern P2 toward a side of the pattern P3 and the width of the pattern P3 toward the side of the pattern P2 by the bias amount B23. As a result, the bias amounts B12 and B23 different from each other on the side of the pattern P1 and the side of the pattern P3 may be applied with respect to the pattern P2. Therefore, in the simulation processing of the polishing process, a reproducibility of the area ratio of the pattern P formed in the actual film forming process can be improved.

### 2. Second Embodiment

Next, a simulation device according to a second embodiment will be described. The second embodiment is different from the first embodiment in a point that a bias amount is updated under the simulation processing of the polishing process. The following description mainly describes a configuration and an operation, which are different from those of the first embodiment. For a configuration and an operation equal to those of the first embodiment, the description will appropriately not be shown.

### 2.1 Cross-Sectional Structure of Stacked Structure That is Target of Simulation Processing of Polishing Process

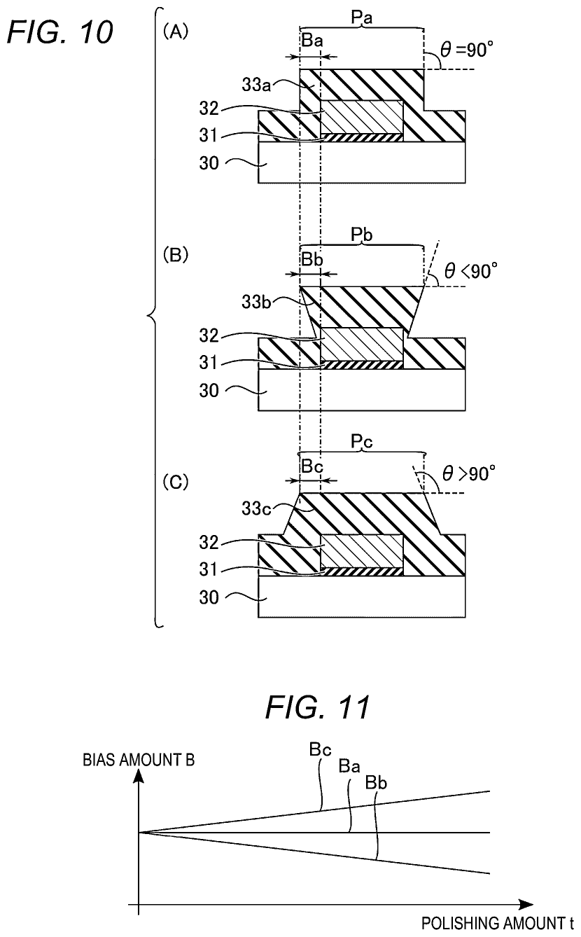

FIG. 10 is a set of cross-sectional diagrams showing an example of a cross-sectional structure of an actual stacked structure that is a target of simulation processing of a polishing process in the simulation device according to the second embodiment. In FIG. 10, a cross-sectional structure after the film forming process is classified into three cases (A), (B), and (C) in accordance with a magnitude of a side wall angle θ. The side wall angle θ is an inclination of the side wall of the pattern P formed by the actual film forming process.

The case (A) shown in an upper part of FIG. 10 is when the side wall angle θ is 90°. In the case (A), an insulator film 33a is provided by the film forming process. A width of a pattern Pa formed by the insulator film 33a has a bias amount Ba with respect to the width of the conductor film 32. The bias amount Ba may be considered to be equal to the bias amount B in the first embodiment. That is, the case (A) corresponds to a case of the first embodiment.

The case (B) shown in a middle part of FIG. 10 is when the side wall angle θ is less than 90°. In the case (B), an insulator film 33b is provided by the film forming process. A bias amount Bb of a width of a pattern Pb formed by the insulator film 33b with respect to the width of the conductor film 32 is equal to the bias amount Ba on the upper surface, but gradually decreases as the conductor film 32 is approached. That is, the pattern Pb has a reverse tapered shape.

The case (C) shown in a lower part of FIG. 10 is when the side wall angle θ is more than 90°. In the case (C), an insulator film 33c is provided by the film forming process. A bias amount Bc of a width of a pattern Pc formed by the insulator film 33c with respect to the width of the conductor film 32 is equal to the bias amount Ba on the upper surface, but gradually increases as the conductor film 32 is approached. That is, the pattern Pc has a forward tapered shape.

Among the above-described three cases, a result in which a polishing process with respect to the cases (B) and (C) is executed may be different from a result in which a polishing process with respect to the case (A) is executed. In the second embodiment, a difference between the case (B) and the case (C) and the case (A) is taken into consideration in the simulation processing. Specifically, the polishing process simulation unit 27 executes the simulation processing of the polishing process in a plurality of divided times. The polishing process simulation unit 27 applies different bias amounts B to each of a plurality of pieces of simulation processing of polishing processes executed in a divided manner.

### 2.2 Bias Amount

FIG. 11 is a diagram showing an example of a bias amount applied to the simulation device according to the second embodiment.

As described above, the width of the pattern P formed by the film forming process may change depending on the side wall angle θ. In the second embodiment, each of the bias amounts Ba, Bb, and Bc is defined with respect to the three cases (A), (B), and (C) based on the side wall angle.

As shown in FIG. 11, when the side wall angle θ is 90° (case (A)), the bias amount Ba does not change regardless of a polishing amount t. On the other hand, when the side wall angle θ is less than 90° (case (B)), the bias amount Bb decreases in accordance with the polishing amount t. Further, when the side wall angle θ is more than 90° (case (C)), the bias amount Bc increases in accordance with the polishing amount t.

### 2.3 Flowchart

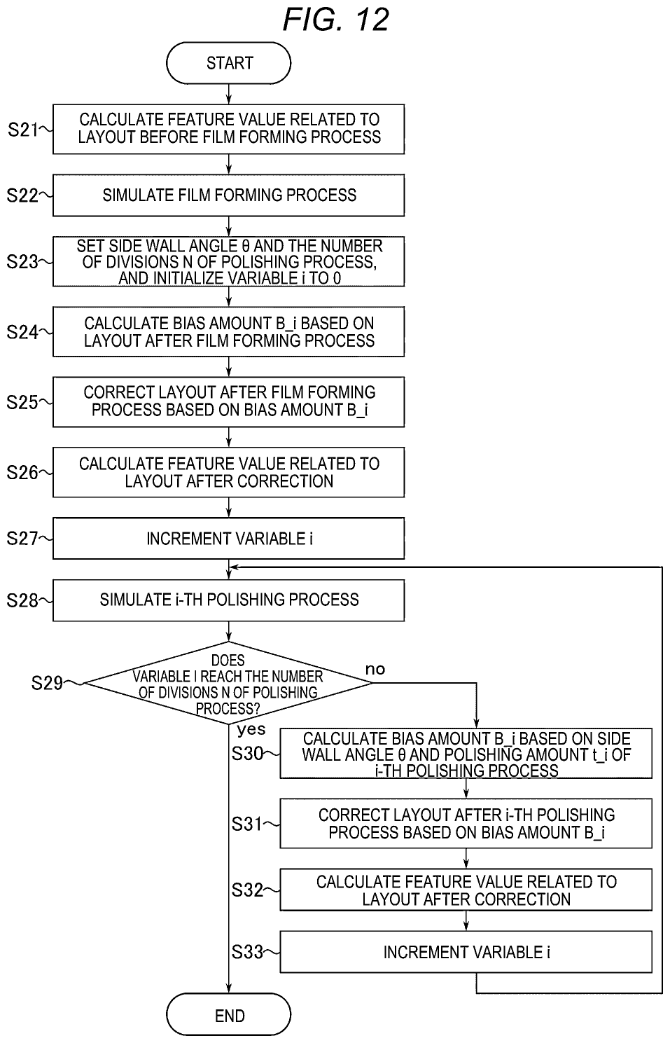

FIG. 12 is a flowchart showing an example of simulation processing involving layout correction processing in the simulation device according to the second embodiment. FIG. 12 corresponds to FIG. 6 in the first embodiment.

When the instruction to start the simulation processing of the film forming process is received from the user (start), the feature value calculation unit 23 calculates the feature value related to the layout data 21 before the film forming process (S21).

The film forming process simulation unit 26 executes the simulation processing of the film forming process based on the feature value calculated in the processing of S21 (S22).

The bias amount calculation unit 24 sets the side wall angle θ related to the pattern P formed in the processing of S22 and the number of divisions N of the simulation processing of the polishing process. In addition, the polishing process simulation unit 27 initializes a variable i to 0 (S23). The variable i corresponds to the number of polishing process times and is an integer equal to or more than 0 and equal to or less than N.

The bias amount calculation unit 24 calculates a bias amount B_i (=B_0) based on the layout data 21 updated in the processing of S22 with reference to the rule table 22 (S24). Specifically, the bias amount calculation unit 24 calculates a bias amount B_0 based on the space W between the adjacent patterns P. Here, when the side wall angle θ is 90°, the bias amount calculation unit 24 calculates a bias amount Ba_0. When the side wall angle θ is less than 90°, the bias amount calculation unit 24 calculates a bias amount Bb_0. When the side wall angle θ is more than 90°, the bias amount calculation unit 24 calculates a bias amount Bc_0. As shown in FIG. 10, after the film forming process, it is expected that bias amounts B_0 will be equal to each other regardless of the side wall angle θ. Therefore, the bias amounts Ba_0, Bb_0, and Bc_0 are set to equal values.

The layout correction unit 25 corrects the layout data 21 based on the bias amount B_0 calculated in the processing of S24 (S25). Specifically, the layout correction unit 25 widens the width of each of the two patterns P such that the space W between the two adjacent patterns P is narrowed in accordance with the bias amount B_0.

The feature value calculation unit 23 calculates the feature value related to the corrected layout data 21 by the processing of S25 (S26).

The polishing process simulation unit 27 increments the variable i (S27). That is, when the variable i=1, the bias amount B_0=B_(i−1).

The polishing process simulation unit 27 executes simulation processing of an i-th polishing process based on the feature value calculated in the processing of S26 (S28). As a result, the simulation processing of the polishing process based on the pattern P in consideration of the bias amount B_(i−1) is executed. After the processing of S28, the layout data 21 is updated in accordance with the pattern P after the polishing. In the simulation processing of the i-th polishing process, the pattern P is removed in a stacking direction by a polishing amount t_i smaller than a final polishing amount.

After the processing of S28, the polishing process simulation unit 27 determines whether the variable i reaches the number of divisions N of the polishing process (S29).

When the variable i does not reach the number of divisions N of the polishing process (S29; no), the bias amount calculation unit 24 calculates the bias amount B_i based on the layout data 21 after the i-th polishing process, based on the side wall angle θ set in the processing of S23 and the i-th polishing amount t_i (S30). Specifically, the bias amount calculation unit 24 calculates the bias amount B_i based on the following Equation (1).

$$B\_i = B\_ ( i - 1 ) - t\_i / tan ( θ ) \qquad ( 1 )$$

The layout correction unit 25 corrects the layout data 21 after the i-th polishing process based on the bias amount B_i calculated in the processing of S30 (S31).

The feature value calculation unit 23 calculates the feature value related to the corrected layout data 21 by the processing of S31 (S32).

The polishing process simulation unit 27 increments the variable i (S33). That is, when the variable i=2, a bias amount B_1=B_(i−1).

After the processing of S33, the polishing process simulation unit 27 executes the simulation processing of the i-th polishing process based on the feature value calculated in the processing of S32 (S28). Then, the subsequent processing of S29 is executed. In this way, processing of S30 to S33, S28, and S29 are repeatedly executed until the variable i reaches the number of divisions N of the polishing process.

When the variable i reaches the number of divisions N of the polishing process (S29; yes), the simulation processing involving the layout correction processing is ended (end).

### 2.4 Specific Example

Next, a specific example of the simulation processing involving the layout correction processing in the simulation device according to the second embodiment will be described. Hereinafter, for convenience of descriptions, when the number of divisions N=3, of the polishing process will be described.

### 2.4.1 Case (B)

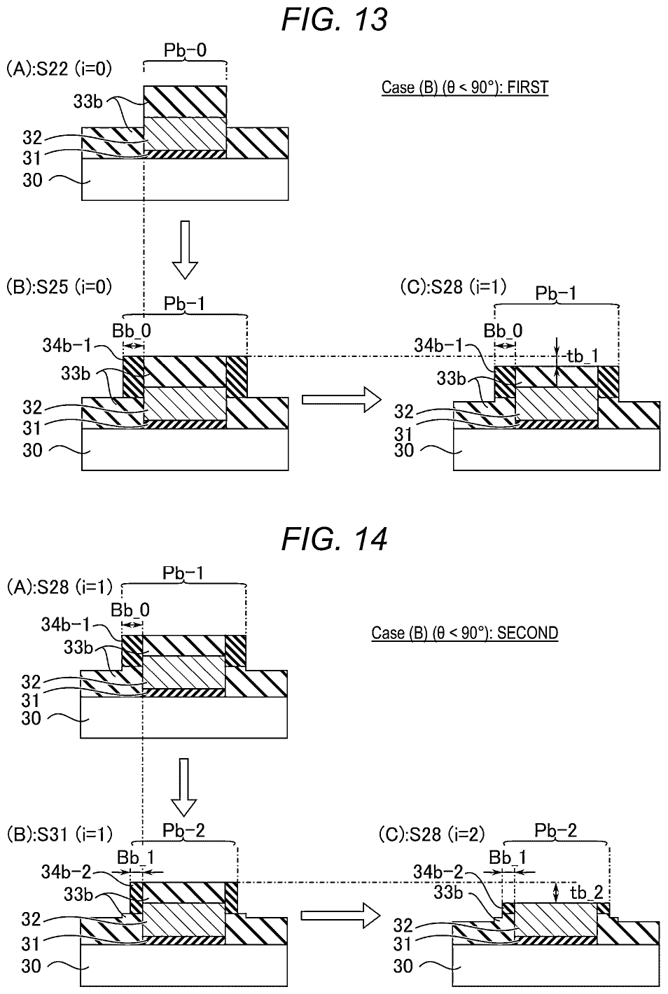

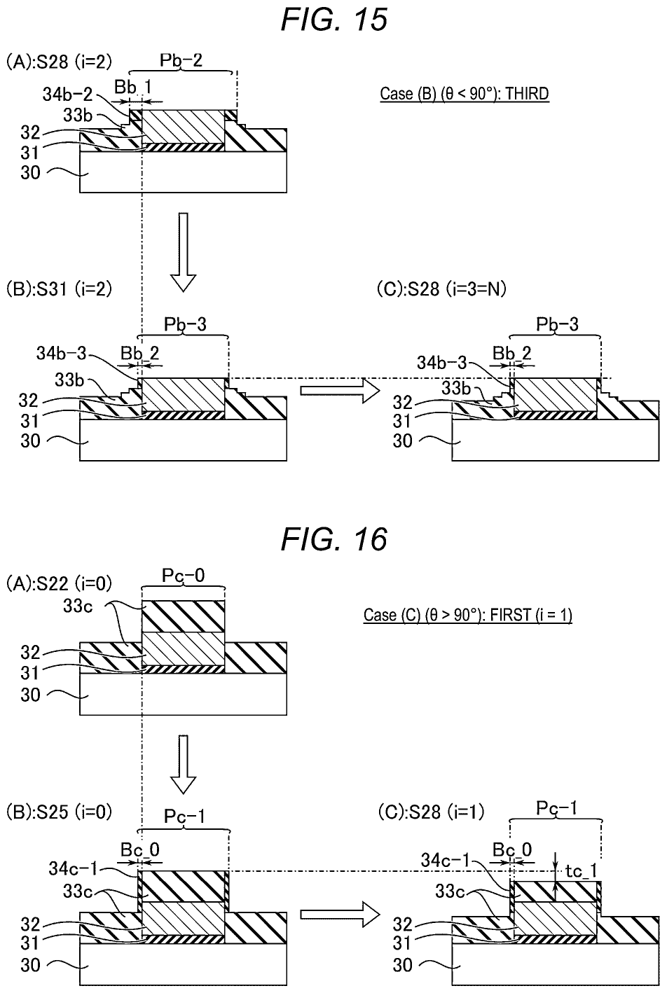

FIG. 13 is a set of cross-sectional diagrams showing a first example of first layout correction processing and polishing process simulation processing in the simulation device according to the second embodiment. FIG. 14 is a set of cross-sectional diagrams showing a first example of second layout correction processing and polishing process simulation processing in the simulation device according to the second embodiment. FIG. 15 is a set of cross-sectional diagrams showing a first example of third layout correction processing and polishing process simulation processing in the simulation device according to the second embodiment. The first example corresponds to the case (B).

First, the first layout correction processing and polishing process simulation processing in the case (B) will be described with reference to FIG. 13. Each of cross-sectional structures shown in parts (A), (B), and (C) of FIG. 13 corresponds to after the simulation processing of the film forming process (S22 (i=0)), after the first layout correction processing (S25 (i=0)), and after the simulation processing of the first polishing process (S28 (i=1)).

As shown in the part (A) of FIG. 13, the insulator film 33b is provided over an entire surface by the simulation processing of the film forming process. As described above, the shape of the pattern Pb is substantially maintained before and after the simulation processing of the film forming process. Therefore, a width of the insulator film 33b forming a pattern Pb-0 is substantially equal to a width of a portion of the conductor film 32.

Therefore, the bias amount calculation unit 24 calculates the bias amount Bb_0 equal to that when the side wall angle e is 90°, based on the rule table 22.

As shown in the part (B) of FIG. 13, the layout correction unit 25 corrects the layout data 21 based on the bias amount Bb_0. Specifically, the layout correction unit 25 adds a virtual insulator film 34b-1 having a width of the bias amount Bb_0 to a side wall of the insulator film 33b on the upper surface of the conductor film 32. As a result, the pattern Pb-0 is corrected to a pattern Pb-1.

Subsequently, as shown in the part (C) of FIG. 13, by the simulation processing of the first polishing process, the insulator film 33b and the insulator film 34b-1 on the upper surface of the conductor film 32 are removed by a first polishing amount tb_1. Accordingly, a region of which the insulator film 33b is provided on the side of the conductor film 32 and that is not protected by the insulator film 34b-1 is also slightly removed.

Next, the second layout correction processing and polishing process simulation processing in the case (B) will be described with reference to FIG. 14. Each of cross-sectional structures shown in parts (A), (B), and (C) of FIG. 14 corresponds to after the simulation processing of the first polishing process (S28 (i=1)), after the second layout correction processing (S31 (i=1)), and after the simulation processing of the second polishing process (S28 (i=2)).

As shown in the part (A) of FIG. 14, a width of the pattern Pb-1 after the simulation processing of the first polishing process is substantially equal to a width of the pattern Pb-1 before the simulation processing of the first polishing process.

Meanwhile, in the case (B), the actual width of the insulator film 33b is narrower after the first polishing process than that before the first polishing process. Therefore, the bias amount calculation unit 24 substitutes the first polishing amount tb_1, the bias amount Bb_0, and the side wall angle e into the above-described Equation (1) and calculates a bias amount Bb_1 smaller than the bias amount Bb_0.

As shown in the part (B) of FIG. 14, the layout correction unit 25 corrects the layout data 21 based on the bias amount Bb_1. Specifically, the layout correction unit 25 adds a virtual insulator film 34b-2 having a width of the bias amount Bb_1 to the side wall of the insulator film 33b on the upper surface of the conductor film 32. As a result, the pattern Pb-1 is corrected to a pattern Pb-2.

Subsequently, as shown in the part (C) of FIG. 14, by the simulation processing of the second polishing process, the insulator film 33b and the insulator film 34b-2 on the upper surface of the conductor film 32 are removed by a second 2 polishing amount tb_2. Accordingly, a region of which the insulator film 33b is provided on the side of the conductor film 32 and that is not protected by the insulator film 34b-2 is also slightly removed.

Next, the third layout correction processing and polishing process simulation processing in the case (B) will be described with reference to FIG. 15. Each of cross-sectional structures shown in parts (A), (B), and (C) of FIG. 15 corresponds to after the simulation processing of the second polishing process (S28 (i=2)), after the third layout correction processing (S31 (i=2)), and after the simulation processing of the third polishing process (S28 (i=3=N)).

As shown in the part (A) of FIG. 15, a width of the pattern Pb-2 after the simulation processing of the second polishing process is substantially equal to a width of the pattern Pb-2 before the simulation processing of the second polishing process.

Meanwhile, in the case (B), the actual width of the insulator film 33b is narrower after the second polishing process than that before the second polishing process. Therefore, the bias amount calculation unit 24 substitutes the second polishing amount tb_2, the bias amount Bb_1, and the side wall angle θ into the above-described Equation (1) and calculates a bias amount Bb_2 smaller than the bias amount Bb_1.

As shown in the part (B) of FIG. 15, the layout correction unit 25 corrects the layout data 21 based on the bias amount Bb_2. Specifically, the layout correction unit 25 adds a virtual insulator film 34b-3 having a width of the bias amount Bb_2 on an upper surface of the insulator film 33b on the side of the conductor film 32. As a result, the pattern Pb-2 is corrected to a pattern Pb-3.

Subsequently, as shown in the part (C) of FIG. 15, by the simulation processing of the third polishing process, a region of the insulator film 33b, which is not protected by the insulator film 34b-3 is slightly removed.

By the processing as described above, a level difference shape of the insulator film 33b may be obtained by taking into consideration the side wall angle θ less than 90°.

### 2.4.2 Case (C)

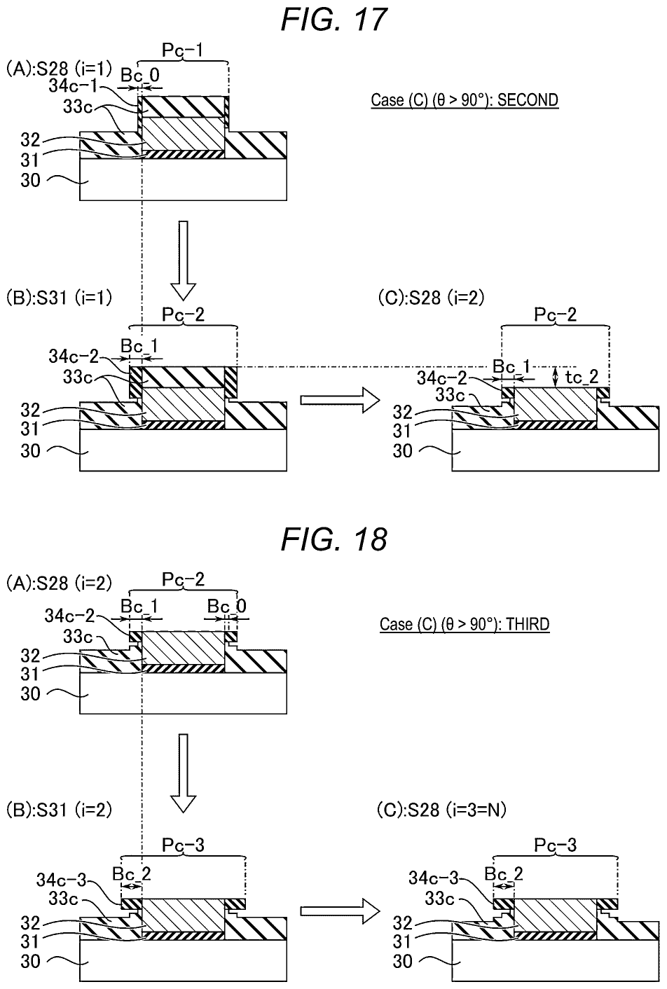

FIG. 16 is a set of cross-sectional diagrams showing a second example of the first layout correction processing and polishing process simulation processing in the simulation device according to the second embodiment. FIG. 17 is a set of cross-sectional diagrams showing a second example of the second layout correction processing and polishing process simulation processing in the simulation device according to the second embodiment. FIG. 18 is a set of cross-sectional diagrams showing a second example of the third layout correction processing and polishing process simulation processing in the simulation device according to the second embodiment. The second example corresponds to the case (C).

First, the first layout correction processing and polishing process simulation processing in the case (C) will be described with reference to FIG. 16. Each of cross-sectional structures shown in parts (A), (B), and (C) of FIG. 16 corresponds to after the simulation processing of the film forming process (S22 (i=0)), after the first layout correction processing (S25 (i=0)), and after the simulation processing of the first polishing process (S28 (i=1)).

As shown in the part (A) of FIG. 16, the insulator film 33c is provided over an entire surface by the simulation processing of the film forming process. As described above, the shape of the pattern Pc is substantially maintained before and after the simulation processing of the film forming process. Therefore, a width of the insulator film 33c forming a pattern Pc-0 is substantially equal to the width of the portion of the conductor film 32.

Therefore, the bias amount calculation unit 24 calculates the bias amount Bc_0 equal to that when the side wall angle θ is 90°, based on the rule table 22.

As shown in the part (B) of FIG. 16, the layout correction unit 25 corrects the layout data 21 based on the bias amount Bc_0. Specifically, the layout correction unit 25 adds a virtual insulator film 34c-1 having a width of the bias amount Bc_0 to a side wall of the insulator film 33c on the upper surface of the conductor film 32. As a result, the pattern Pc-0 is corrected to a pattern Pc-1.

Subsequently, as shown in the part (C) of FIG. 16, by the simulation processing of the first polishing process, the insulator film 33c and the insulator film 34c-1 on the upper surface of the conductor film 32 are removed by a first polishing amount tc_1. Accordingly, a region of which the insulator film 33c is provided on the side of the conductor film 32 and that is not protected by the insulator film 34c-1 is also slightly removed.

Next, the second layout correction processing and polishing process simulation processing in the case (C) will be described with reference to FIG. 17. Each of cross-sectional structures shown in parts (A), (B), and (C) of FIG. 17 corresponds to after the simulation processing of the first polishing process (S28 (i=1)), after the second layout correction processing (S31 (i=1)), and after the simulation processing of the second polishing process (S28 (i=2)).

As shown in the part (A) of FIG. 17, a width of the pattern Pc-1 after the simulation processing of the first polishing process is substantially equal to a width of the pattern Pc-1 before the simulation processing of the first polishing process.

Meanwhile, in the case (C), the actual width of the insulator film 33c is wider after the first polishing process than that before the first polishing process. Therefore, the bias amount calculation unit 24 substitutes the first polishing amount tc_1, the bias amount Bc_0, and the side wall angle e into the above-described Equation (1) and calculates a bias amount Bc_1 larger than the bias amount Bc_0.

As shown in the part (B) of FIG. 17, the layout correction unit 25 corrects the layout data 21 based on the bias amount Bc_1. Specifically, the layout correction unit 25 adds a virtual insulator film 34c-2 having a width of the bias amount Bc_1 to the side wall of the insulator film 33c on the upper surface of the conductor film 32. As a result, the pattern Pc-1 is corrected to a pattern Pc-2.

Subsequently, as shown in the part (C) of FIG. 17, by the simulation processing of the second polishing process, the insulator film 33c and the insulator film 34c-2 on the upper surface of the conductor film 32 are removed by a second polishing amount tc_2. Accordingly, a region of which the insulator film 33c is provided on the side of the conductor film 32 and that is not protected by the insulator film 34c-2 is also slightly removed.

Next, the third layout correction processing and polishing process simulation processing in the case (C) will be described with reference to FIG. 18. Each of cross-sectional structures shown in parts (A), (B), and (C) of FIG. 18 corresponds to after the simulation processing of the second polishing process (S28 (i=2)), after the third layout correction processing (S31 (i=2)), and after the simulation processing of the third polishing process (S28 (i=3=N)).

As shown in the part (A) of FIG. 18, a width of the pattern Pc-2 after the simulation processing of the second polishing process is substantially equal to a width of the pattern Pc-2 before the simulation processing of the second polishing process.

Meanwhile, in the case (C), the actual width of the insulator film 33c is wider after the second polishing process than that before the second polishing process. Therefore, the bias amount calculation unit 24 substitutes the second polishing amount tc_2, the bias amount Bc_1, and the side wall angle θ into the above-described Equation (1) and calculates a bias amount Bc_2 larger than the bias amount Bc_1.

As shown in the part (B) of FIG. 18, the layout correction unit 25 corrects the layout data 21 based on the bias amount Bc_2. Specifically, the layout correction unit 25 adds a virtual insulator film 34c-3 having a width of the bias amount Bc_2 on an upper surface of the insulator film 33c on the side of the conductor film 32. As a result, the pattern Pc-2 is corrected to a pattern Pc-3.

Subsequently, as shown in the part (C) of FIG. 18, by the simulation processing of the third polishing process, a region of the insulator film 33c, which is not protected by the insulator film 34c-3 is slightly removed.

By the processing as described above, a level difference shape of the insulator film 33c may be obtained by taking into consideration the side wall angle θ more than 90°.

### 2.5 Effects According to Second Embodiment

According to the second embodiment, the polishing process simulation unit 27 executes the simulation processing of the first polishing process, based on the feature value of the corrected layout data 21 after the simulation processing of the film forming process. The bias amount calculation unit 24 calculates the bias amount B_1 based on the bias amount B_0 applied to the simulation processing of the first polishing process, a polishing amount t_1 by the simulation processing of the first polishing process, and the side wall angle θ of the pattern P after the actual film forming process. The layout correction unit 25 corrects the bias amount B applied to the layout data 21, from the bias amount B_0 to the bias amount B_1. The feature value calculation unit 23 calculates the feature value of the layout data 21 to which the bias amount B_1 is applied. The polishing process simulation unit 27 executes the simulation processing of the second polishing process based on the feature value of the corrected layout data 21 after the simulation processing of the first polishing process. As a result, the simulation processing can be executed while the bias amount B is applied, which is different in accordance with a progress level of the polishing process. Therefore, when the pattern P has the forward tapered shape and even when the pattern P has the reverse tapered shape, a level difference shape of the stacked structure after the polishing process can be simulated while the shapes are taken into consideration. Therefore, an accuracy of the level difference shape after the polishing process can be improved.

### 3. Modification Examples and The Like

Various modifications may be applied to the first embodiment and the second embodiment described above.

In the second embodiment described above, when the simulation processing of the polishing process is executed in a plurality of divided times with respect to one layer of the insulator film 33 is described, but the present disclosure is not limited thereto. For example, the simulation processing of the polishing process may be executed with respect to a stacked film with a plurality of layers. In this situation, the simulation processing of the polishing process may be divided to correspond to each of the plurality of films. As a result, a film quality for each film with the plurality of layers can be further considered. Therefore, the level difference shape generated in the insulator film 33 after the simulation processing of the polishing process may be brought close to an actual shape.

In the first embodiment and the second embodiment described above, when a planar shape of the pattern P such as the space W is applied as a parameter determining the bias amount B is described, but the present disclosure is not limited thereto. For example, as the parameter for determining the bias amount B, a three-dimensional shape of the pattern P may be applied, which includes the conductor film 32 (that is, dimension of gate of transistor), a thickness of the conductor film 32, and a thickness of the insulator film 33 provided above the conductor film 32 by the film forming process and the like, in addition to the space W.

In the first embodiment and the second embodiment described above, when a program executing the simulation processing involving the layout correction processing is executed by the simulation device 1 is described, but the present disclosure is not limited thereto. For example, the program executing simulation processing involving the layout correction processing may be executed by a calculation resource on a cloud.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A simulation method comprising:
correcting a layout of a stacked structure based on a shape of the stacked structure;
calculating a first feature value of the corrected layout; and
simulating a polishing process for the corrected layout based on the first feature value.

2. The simulation method according to claim 1, wherein
the layout of the stacked structure includes a first pattern and a second pattern adjacent to each other, and
the correcting includes:
calculating a first bias amount based on a first space between the first pattern and the second pattern; and
widening a width of the second pattern toward a side of the first pattern by the first bias amount.

3. The simulation method according to claim 2, wherein
the correcting further includes widening a width of the first pattern toward a side of the second pattern by the first bias amount.

4. The simulation method according to claim 2, wherein
the layout of the stacked structure further includes a third pattern with a third width, wherein the third pattern is located on a side opposite to the first pattern with respect to the second pattern, and located adjacent to the second pattern, and
the correcting includes correcting the layout based on the first space and a second space between the second pattern and the third pattern.

5. The simulation method according to claim 4, wherein
the correcting includes:
calculating the first bias amount based on the first space;
widening the width of the second pattern toward the side of the first pattern by the first bias amount;
calculating a second bias amount based on the second space; and
widening the width of the second pattern toward a side of the third pattern by the second bias amount.

6. The simulation method according to claim 5, wherein
the correcting further includes:
widening a width of the first pattern toward a side of the second pattern by the first bias amount; and
widening a width of the third pattern toward the side of the second pattern by the second bias amount.

7. The simulation method according to claim 1, wherein
the first feature value includes an area ratio, a width, and a perimeter length of a pattern included in the layout.

8. The simulation method according to claim 2, wherein
the simulating includes:
simulating a first polishing process for the corrected layout based on the first feature value;
calculating a second bias amount based on the first bias amount, a polishing amount of the stacked structure in the first polishing process, and a side wall angle related to the second pattern;
correcting the width of the second pattern widened toward the side of the first pattern from the first bias amount to the second bias amount;
calculating a second feature value of the corrected layout after simulating the first polishing process; and
simulating a second polishing process for the corrected layout after simulating the first polishing process based on the second feature value.

9. The simulation method according to claim 8, wherein
the second bias amount is smaller than the first bias amount.

10. The simulation method according to claim 8, wherein
the second bias amount is larger than the first bias amount.

11. The simulation method according to claim 1, wherein the stacked structure includes a plurality of films with respectively different film types.

12. A non-transitory computer-readable storage medium storing a program for causing a computer to execute a process, the process comprising:
correcting a layout of a stacked structure based on a shape of the stacked structure;
calculating a first feature value of the corrected layout; and
simulating a polishing process for the corrected layout based on the first feature value.

13. The non-transitory computer-readable storage medium according to claim 12, wherein
the layout of the stacked structure includes a first pattern and a second pattern adjacent to each other, and
the correcting includes:
calculating a first bias amount based on a first space between the first pattern and the second pattern; and
widening a width of the second pattern toward a side of the first pattern by the first bias amount.

14. The non-transitory computer-readable storage medium according to claim 13, wherein
the correcting further includes widening a width of the first pattern toward a side of the second pattern by the first bias amount.

15. The non-transitory computer-readable storage medium according to claim 13, wherein
the layout of the stacked structure further includes a third pattern with a third width, wherein the third pattern is located on a side opposite to the first pattern with respect to the second pattern, and located adjacent to the second pattern, and
the correcting includes correcting the layout based on the first space and a second space between the second pattern and the third pattern.

16. The non-transitory computer-readable storage medium according to claim 15, wherein
the correcting includes:
calculating the first bias amount based on the first space;
widening the width of the second pattern toward the side of the first pattern by the first bias amount;
calculating a second bias amount based on the second space; and
widening the width of the second pattern toward a side of the third pattern by the second bias amount.

17. The non-transitory computer-readable storage medium according to claim 16, wherein
the correcting further includes:
widening a width of the first pattern toward a side of the second pattern by the first bias amount; and
widening a width of the third pattern toward the side of the second pattern by the second bias amount.

18. The non-transitory computer-readable storage medium according to claim 12, wherein the first feature value includes an area ratio, a width, and a perimeter length of a pattern included in the layout.

19. The non-transitory computer-readable storage medium according to claim 13, wherein
the simulating includes:
simulating a first polishing process for the corrected layout based on the first feature value;
calculating a second bias amount based on the first bias amount, a polishing amount of the stacked structure in the first polishing process, and a side wall angle related to the second pattern;
correcting the width of the second pattern widened toward the side of the first pattern from the first bias amount to the second bias amount;
calculating a second feature value of the corrected layout after simulating the first polishing process; and
simulating a second polishing process for the corrected layout after simulating the first polishing process based on the second feature value.

20. The non-transitory computer-readable storage medium according to claim 12, wherein the stacked structure includes a plurality of films with respectively different film types.
